(19) United States
(12) Patent Application Publication
(10) Pub. No.: US 2004/0085668 A1
(43) Pub. Date: May 6, 2004

(54) Disk drive and method for controlling driving voltage of spindle motor applied to disk drive

(75) Inventor: Nobuyuki Sakamoto, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/678,310

(22) Filed: Oct. 6, 2003

(30) Foreign Application Priority Data
Oct. 31, 2002 (JP) 2002-318620

(51) Int. Cl. G11B 15/46

(52) U.S. Cl. 360/73.03; 369/53.3

(57) ABSTRACT

A voltage determination unit dynamically determines a first voltage required to maintain the rotational speed of a spindle motor (SPM) at the rated rotational speed according to a rotational state of the SPM. A CPU determines a second voltage for driving the SPM by software processing in a software control mode. A voltage generator generates the first voltage determined by the voltage determination unit as driving voltage in a hardware control mode and generates the second voltage determined by the CPU as the driving voltage in the software control mode. A driver circuit drives the SPM by the driving voltage generated with the voltage generator.

### CROSS-REFERENCE TO RELATED APPLICATIONS

This application is based upon and claims the benefit of priority from the prior Japanese Patent Application No. 2002-318620, filed Oct. 31, 2002, the entire contents of which are incorporated herein by reference.

### BACKGROUND OF THE INVENTION

1. Field of the Invention

The present invention relates to a disk drive using a disk as a recording medium, and particularly relates to a method for controlling the driving voltage for driving the spindle motor rotating the disk.

2. Description of the Related Art

In general, disk drives using disks as a recording medium utilize a motor, called a spindle motor, to rotate the disks at high speed. Spindle motors are brushless DC motors. A voltage E necessary to drive a brushless direct-current motor, such as a spindle motor, is expressed by the following equation:

E=V_{B}+I×R (1)

In equation (1), V_{B} is a voltage (hereinafter, referred to as a back EMF voltage) that corresponds to a back electromotive force (back EMF) generated in the motor coil as a result of the rotation of the motor. The back EMF voltage V_{B} is proportional to the torque constant and the rotational speed. I is the current flowing through the motor coil. R is the sum of the resistance of the motor coil and the resistance of the motor driver. The current I is proportional to the driving torque of the motor. Therefore, for example, when the motor load changes as a result of a change in ambient temperature, the current I fluctuates accordingly. The torque constant and the coil resistance varies due to the characteristics of the motor. For this reason, the driving voltage of the motor is designed to be higher than E to allow a margin, taking those variations into account.

The margin, however, results in power loss in the motor driver that drives the motor. Thus, when the driving voltage of the motor is designed, allowing for a margin, this causes the problem of increasing the power consumption. This problem becomes particularly significant in fluid dynamics bearing spindle motors which are becoming increasingly popular nowadays as spindle motors used in hard disk motors. The reason is that, in a fluid dynamics bearing spindle motor, the viscosity of fluid (e.g., oil) increases with the ambient temperature and therefore the load on the motor fluctuates significantly. Obviously, a great change in the motor load results in a large fluctuation in the driving voltage E. Thus, it is necessary to allow a large margin for the motor driving voltage actually used, taking fluctuations in the driving voltage E into account. Allowing a large margin for the motor driving voltage increases the power loss in the motor driver accordingly. A technique for reducing the power loss in a motor driver has been disclosed in Jpn. Pat. Appln. KOKAI Publication No. 4-208091. In this technique (hereinafter, referred to as the prior art), the driving voltage (or supply voltage) is changed by a power supply unit capable of changing the voltage. The driving voltage is the voltage necessary for the motor driver to drive the motor. The voltage is varied according to the increase or decrease in the current flowing through the motor coil. By this variable control, the difference between the terminal voltage (or coil terminal voltage) of the motor and the driving voltage is minimized, which reduces the loss in the motor driver.

Incidentally, the terminal voltage of the motor largely fluctuates, due to fluctuation in the motor load or abnormalities of the motor. However, the prior art cannot quickly cope with the large fluctuation of the terminal voltage of the motor. That is, in the prior art, when the control of the driving voltage of the spindle motor is realized with hardware, there is a possibility that it takes a long time to return to the rated rotational speed (steady-state rotational speed) when the rotational speed of the motor is largely decreased. In starting the spindle motor, the voltage is not generated between the motor terminals (coil terminals). Therefore, when the control of the driving voltage of the spindle motor is realized with hardware, a large amount of current cannot flow into the motor immediately after starting the spindle motor. In this case, there is the possibility that it takes a long time to return to the rated rotational speed.

### BRIEF SUMMARY OF THE INVENTION

According to one embodiment of the invention, the disk drive using the disk as the recording medium is provided. The disk drive includes a spindle motor which rotates the disk, a voltage determination unit, a CPU, a voltage generator, and a driver circuit. The voltage determination unit dynamically determines a first voltage for driving the spindle motor according to a rotational state of the spindle motor. The first voltage is a voltage required to maintain the rotational speed of the spindle motor at the rated rotational speed. The CPU determines a second voltage for driving the spindle motor by software processing in a software control mode. The voltage generator generates driving voltage for driving the spindle motor. The generator generates the first voltage determined by the voltage determination unit as the driving voltage in a hardware control mode and generates the second voltage determined by the CPU as the driving voltage in the software control mode. The driver circuit drives the spindle motor by the driving voltage generated with the voltage generator.

### BRIEF DESCRIPTION OF THE SEVERAL VIEWS OF THE DRAWING

FIG. 1 is a block diagram showing a configuration of the hard disk drive according to an embodiment of the invention; and

FIG. 2 is a flow chart showing control procedure for starting SPM 11 to drive SPM 11 at the rated rotational speed in the embodiment.

### DETAILED DESCRIPTION OF THE INVENTION

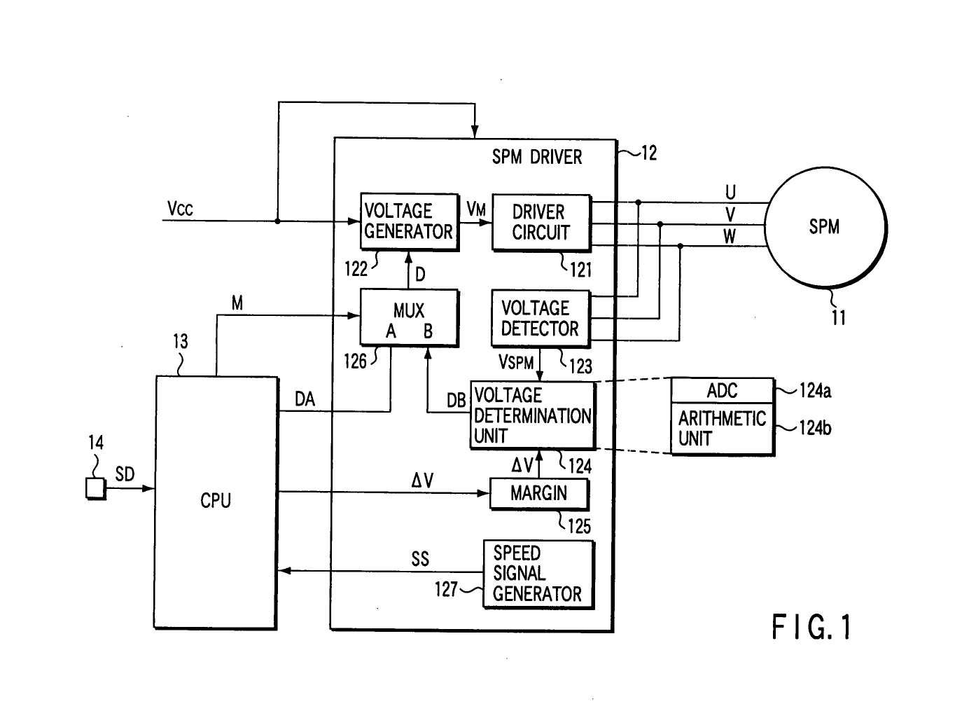

An embodiment in which the invention is applied to the hard disk drive will be described below referring to the accompanying drawings. FIG. 1 is the block diagram showing the configuration of the hard disk drive according to one embodiment of the invention. The hard disk drive (hereinafter referred to as HDD) shown in FIG. 1 includes a spindle motor (hereinafter referred to as SPM) 11, an SPM driver 12, a CPU 13, and a shock sensor 14. The shock sensor 14 detects an impact applied to the HDD from the outside. The shock sensor 14 outputs an effective impact detection signal SD when the impact exceeding a predetermined threshold is applied to the HDD. The signal SD is supplied to the CPU 13.

The SPM 11 is used for rapidly rotating a magnetic disk (not shown) used the recording medium of the HDD. The SPM 11 is, e.g. a three-phase, twelve-pole motor. The SPM 11 has three-phase motor coils. These three phases are usually indicated by U, V, and W. One end of each of the three-phase motor coils is commonly connected. In the SPM 11, the commonly connected terminal is referred to as terminal COM. The other terminals of each of the three-phase motor coils are referred to as terminals U, V, and W. In FIG. 1, the terminals U, V, and W of the three-phase motor coils are indicated and the terminal COM is omitted.

The SPM driver 12 drives the SPM 11 by supplying current to the SPM 11. The SPM driver 12 is operated by supply voltage V_{CC} of, e.g. 5V. The supply voltage V_{CC} is applied from, e.g. a host (not shown). The host is an electronic instrument utilizing the HDD shown in FIG. 1. In this case, it is assumed that the host is a personal computer (PC). That is, in the embodiment, it is assumed that the HDD shown in FIG. 1 is used as a storage device of PC.

The CPU 13 functions as a controller controlling each portion in the HDD by executing a control program (software). The control program is stored in a non-volatile memory such as a ROM. The CPU 13 selects and sets either a hardware control mode or a software control mode as the mode of the HDD. Voltage (motor driving voltage) V_{M} applied to a driving circuit 121 described later is controlled by setting the mode.

The hardware control mode is the mode in which the motor driving voltage V_{M} is automatically controlled with the SPM driver 12. In the hardware control mode, the motor driving voltage V_{M} is automatically adjusted to minimum voltage (first voltage) VMIN required to rotate the SPM 11 at the rated rotational speed with the SPM driver 12. The minimum voltage VMIN is variably set according to SPM terminal voltage VSPM described later. On the other hand, the software control mode is the mode in which the motor driving voltage V_{M} is controlled to specified voltage (second voltage) V_{H} with the CPU 13. In the embodiment, the voltage V_{H} is higher than the supply voltage V_{CC} and the voltage V_{MIN}. Therefore, sometimes the voltage V_{H} is also referred to as high voltage V_{H}. For example, the software control mode is set in starting the SPM 11 and in the case that the rotational speed of the SPM 11 is largely (rapidly) decreased from the rated rotational speed.

The SPM driver 12 includes a driver circuit 121, a voltage generator 122, a voltage detector 123, a voltage determination unit 124, a margin register 125, a multiplexer (MUX) 126, and a speed signal generator 127. The driver circuit 121 receives the motor driving voltage V_{M} generated with the voltage generator 122 and supplies current for maintaining the rated rotational speed to each phase of U, V, and W of the SPM 11. The voltage generator 122 is a power supply unit which can vary the voltage. The voltage generator 122 generates the voltage whose value is specified by data D from the supply voltage V_{CC}. The voltage generated with the voltage generator 122 is applied to the driver circuit 121 as the motor driving voltage V_{M}. The data D is given from the CPU 13 or the voltage determination unit 124 through the multiplexer 126.

The voltage detector 123 detects the voltage between the ground and each terminal (coil terminal) U, V, and W of the SPM 11 as terminal voltage (SPM terminal voltage) V_{SPM}. The voltage determination unit 124 dynamically determines a value of the motor driving voltage V_{M}, which should be specified to the voltage generator 122, on the basis of the value of the SPM terminal voltage V_{SPM} detected with the voltage detector 123. The voltage determination unit 124 includes an A/D (Analog/Digital) converter (ADC) 124a and an arithmetic unit 124b. The A/D converter 124a converts, in synchrony with a sampling clock, the SPM terminal voltage V_{SPM} detected by the voltage detector 123 into a digital value. The arithmetic unit 124b calculates the value of the motor driving voltage V_{M}, which should be specified to the voltage generator 122, on the basis of the value of the SPM terminal voltage V_{SPM} converted into the digital value with the A/D converter 124a. In the embodiment, the arithmetic unit 124b is an adder which adds the value of the SPM terminal voltage V_{SPM} and a voltage margin ΔV set in the margin register 125. The A/D converter 124a may be also provided independent of the voltage determination unit 124. The margin register 125 is used for holding the voltage margin ΔV. The voltage margin ΔV is set by the CPU 13, e.g. in starting the HDD.

The multiplexer 126 is the two-input, one-output multiplexer having two inputs A and B. A first data DA indicating the value of the motor driving voltage V_{M} determined by the CPU 13 is supplied to the input A of the multiplexer 126. A second data DB indicating the value of the motor driving voltage V_{M} determined by the voltage determination unit 124 is supplied to the input B of the multiplexer 126. The multiplexer 126 selects either the input A (data DA) or the input B (data DB) as the data D according to a mode signal M. The mode signal M indicates which the software control mode or the hardware control mode is set. The CPU 13 changes states of the mode signal M according to the setting of the software control mode or the hardware control mode. The motor driving voltage value (data D) selected with the multiplexer 126 is given to the voltage generator 122. The speed signal generator 127 generates a signal (hereinafter referred to as speed signal) SS of a frequency proportional to the rotational speed of the SPM 11. The speed signal SS consists of a series of pulses which appear in a period determined by the rotational speed of the SPM 11. The speed signal SS generated with the speed signal generator 127 is supplied to the CPU 13.

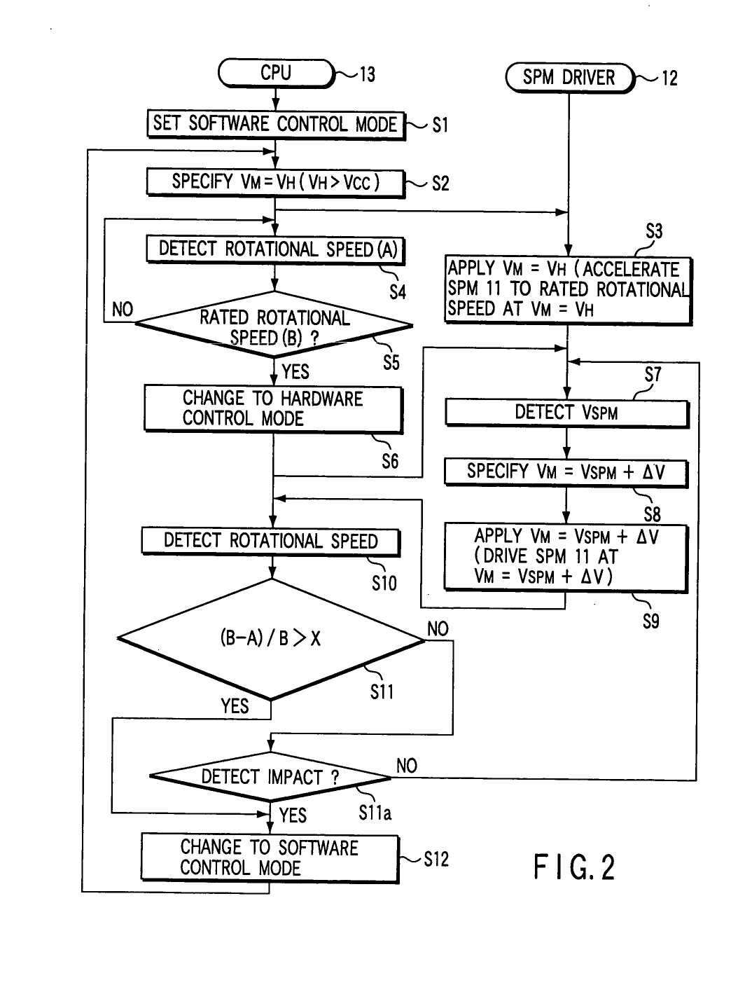

The control procedure, which is executed in the HDD of FIG. 1 and starts the SPM 11 to drive the SPM 11 at the rated rotational speed, will be described below referring to the flow chart of FIG. 2. The CPU 13 sets the HDD to the software control mode, for example, in the case that the SPM 11 is required to start as a result of turning on power supply of the host (PC) (STEP S1). That is, the CPU 13 sets the mode signal M to the state indicating the software control mode, e.g. a low level. In the software control mode, the CPU 13 supplies the data DA specifying the predetermined high voltage V_{H} to the input A of the multiplexer 126 (STEP S2). In other words, the CPU 13 specifies the high voltage V_{H} (V_{H}>V_{CC}) as the required motor driving voltage V_{M} in order that the driver circuit 121 in the SPM driver 12 drives the SPM 11.

The multiplexer 126 selects the data DA supplied to the input A of the multiplexer 126 from the CPU 13 as the data D during the period of the low level, in which the mode signal indicates the software control mode. The data D (=DA) is given to the voltage generator 122. The voltage generator 122 corresponds to the data D given from the multiplexer 126 and generates the voltage of the value specified by the data D from the supply voltage V_{CC}. In the case of the software control mode like this example, the data D is the data DA specifying the high voltage V_{H}. The voltage V_{H} is the voltage having the sufficient level in which the SPM 11 quickly reaches the rated rotational speed in starting the SPM 11 or in the case that the rotational speed of the SPM 11 is largely decreased from the rated rotational speed. The voltage generator 122 generates the high voltage V_{H} (namely the high voltage V_{H} specified with the CPU 13) indicated by the data D (=DA) in a manner that boosts the supply voltage V_{CC} according to the data D (=DA). The high voltage V_{H} generated with the voltage generator 122 is applied to the driver circuit 121 as the motor driving voltage V_{M} (STEP S3). The driver circuit 121 accelerates the SPM 11 to the rated rotational speed by the motor driving voltage V_{M} boosted to the high voltage V_{H} during the software control mode.

As described above, in the embodiment, the SPM 11 is driven irrespective of the SPM terminal voltage V_{SPM} by the high voltage V_{H} in starting the SPM 11. Accordingly, unlike the drive of the SPM by the voltage determined on the basis of the SPM terminal voltage V_{SPM}, the SPM 11 can quickly reach the rated rotational speed.

On the other hand, when the CPU 13 sets the HDD to the software control mode (STEP S1), the CPU 13 detects (calculates) the current rotational speed of the SPM 11 (STEP S4). That is, the CPU 13 detects the current rotational speed of the SPM 11 from a pulse interval of the pulse series (pulse repetition period), which is included in the speed signal SS outputted from the speed signal generator 127 in the SPM driver 12. The CPU 13 decides on the basis of the detected rotational speed whether the SPM 11 reaches the rated rotational speed or not (STEP S5). The CPU 13 repeats the STEPs S4 and S5 at a predetermined interval until the CPU 13 can decide that the SPM 11 has reached the rated rotational speed. In this case, the CPU 13 decides that the SPM 11 has reached the rated rotational speed in the case that the rotational speed of the SPM 11 exceeds the predetermined rotational speed lower than the rated rotational speed for at least a predetermined period.

Then, when the CPU 13 can decide that the SPM 11 has reached the rated rotational speed, the CPU 13 decides that the start of the SPM 11 has completed. In this case, since the CPU 13 reduces the power loss in the SPM driver 12, the CPU 13 changes the mode of the HDD from the software control mode to the hardware control mode (STEP S6). That is, the CPU 13 sets the mode signal to the state indicating the hardware control mode, e.g. high level.

The voltage detector 123 in the SPM driver 12 detects the terminal voltage (SPM terminal voltage V_{SPM}) of the SPM 11, e.g. at predetermined intervals in the operational state (STEP S7). The A/D converter 124a in the voltage determination unit 124 converts, in synchrony with the sampling clock, the SPM terminal voltage V_{SPM} detected by the voltage detector 123 into the digital value. The arithmetic unit 124b in the voltage determination unit 124 calculates the motor driving voltage V_{M} on the basis of the value of the SPM terminal voltage V_{SPM} which has been converted into the digital value with the A/D converter 124a (STEP S8). At this point, the minimum motor driving voltage V_{MIN} required to rotate the SPM 11 at the rated rotational speed is calculated (determined) as the motor driving voltage V_{M}. In the calculation of the motor driving voltage V_{M}=V_{MIN}, the voltage margin ΔV set in the margin register 125 is used in order to allow for the voltage V_{M}=V_{MIN}. Specifically, the voltage V_{M}=V_{MIN} is calculated, according to the following equation, by an adding operation of the adder 124b;

V_{M}=V_{MIN}=V_{SPM}+ΔV (2)

The adding operation of the adder 124b itself is constantly carried out irrespective of, e.g. the mode of the HDD. As can be seen from the equation (2), the voltage V_{M}=V_{MIN} calculated by the adding operation of the arithmetic unit 124b fluctuates according to the fluctuation of the SPM terminal voltage V_{SPM}.

Instead of the detection of the SPM terminal voltage V_{SPM}, current (SPM current) I_{SPM} flowing through the coil of the SPM 11 may be detected. In this case, the motor driving voltage V_{M}=V_{MIN} can be determined by the calculation of the following equation (3);

V_{M}=V_{MIN}=V_{B}+I_{SPM}*R_{SPM}+ΔV (3)

Where R_{SPM} is resistance of the coil of the SPM 11 and V_{B} is the back EMF voltage generated in the coil of the SPM 11 by the rotation of the SPM 11. The calculation is influenced by variations of the resistance R_{SPM} of the coil of the SPM 11 and the variations of the back EMF voltage V_{B}. For this reason, the calculation of the equation (3) is inferior in accuracy to the case in which the voltage V_{M}=V_{MIN} is calculated with the equation (2) using the SPM terminal voltage V_{SPM}.

Similarly to the prior art, in accordance with difference between the current motor driving voltage V_{M} and the SPM terminal voltage V_{SPM}, the new motor driving voltage V_{M}=V_{MIN} may be determined so that the difference is always minimized. In this case, the arithmetic unit 124b in the voltage determination unit 124 may carry out a subtraction operation which calculates the difference between the current motor driving voltage V_{M} and the SPM terminal voltage V_{SPM}.

The voltage determination unit 124 supplies the data DB indicating the value of the motor driving voltage V_{M} (=V_{MIN}) calculated (determined) by the arithmetic unit 124b to the input B of the multiplexer 126 (STEP S8). That is, the voltage determination unit 124 specifies V_{M}=V_{MIN}=V_{SPM}+ΔV as the motor driving voltage V_{M}. The multiplexer 126 selects the data DB supplied to the input B of the multiplexer 126 from the voltage determination unit 124 as the data D for the period of the high level in which the mode signal M indicates the hardware control mode. The data D (=DB) is given to the voltage generator 122.

The voltage generator 122 generates the voltage of the value specified with the data D from the supply voltage V_{CC} according to the data D given from the multiplexer 126. Like this example, in the case of the hardware control mode, the data D is the data DB specifying V_{M}=V_{MIN}=V_{SPM}+ΔV. The voltage V_{MIN} is the minimum motor driving voltage required to maintain the rotational speed of the SPM 11 at rated rotational speed. Accordingly, in the hardware control mode, the voltage generator 122 automatically adjusts the voltage so that the motor driving voltage V_{M} of the output voltage becomes the minimum voltage V_{MIN}=V_{SPM}+ΔV specified with the voltage determination unit 124.

The motor driving voltage V_{M}, which is adjusted to the minimum voltage V_{MIN}=V_{SPM}+ΔV with the voltage generator 122, is applied to the driver circuit 121. The driver circuit 121 drives the SPM 11 during the hardware control mode by the motor driving voltage V_{M} automatically adjusted to the minimum voltage V_{MIN}=V_{SPM}+ΔV (STEP S9). Accordingly, the SPM 11 is driven by the minimum voltage V_{MIN}=V_{SPM}+ΔV required to drive the SPM 11 at the rated rotational speed. As a result, the power loss is suppressed to the minimum amount in the SPM driver 12.

The CPU 13 detects (calculates) the current rotational speed of the SPM 11 from the pulse interval of the pulse series which is included in the speed signal outputted from the speed signal generator 127 (STEP S10). The CPU 13 compares the current rotational speed (A) of the SPM 11 to the target rotational speed (B) (for example, the rated rotational speed) (STEP S11). In STEP S11, it is determined whether the ratio of the difference between the target rotational speed (B) and the rotational speed (A) to the target rotational speed (the rated rational speed) is greater than a predetermined value X (for example, 0.1), that is, whether (B-A)/B>X. When (B-A)/B>X, the CPU 13 changes the mode of the HDD from the hardware control mode to the software control mode in order to quickly return the SPM 11 to the rated rotational speed (STEP S12). That is, the CPU 13 returns the mode of the HDD to the software control mode similar to the mode in starting the SPM 11. The mode of the HDD may be changed to the software control mode when the difference between the target rotational speed (B) and the rotational speed (A) of the SPM 11 is greater than a predetermined value Y, that is, when B-A>Y. The step, in which a rate of a decrease in the rotational speed of the SPM 11 during the period from the previous detecting time to the present detecting time is compared to a predetermined value (for example, 10%) on the basis of the current rotational speed and the rotational speed at the previous detecting time of the SPM 11, may be adopted instead of STEP S11. Thus, the rapid decrease in the rotational speed of the SPM 11 can be detected.

The CPU 13 supplies the data DA specifying the high voltage V_{H} to the input A of the multiplexer 126 in the software control mode (STEP S2). The multiplexer 126 outputs the data DA supplied to the input A of the multiplexer 126 from the CPU 13 as the data D to the voltage generator 122 during the software control mode. The voltage generator 122 boosts the motor driving voltage V_{M} applied to the driver circuit 121 to the high voltage V_{H} specified with the data D (=DA) irrespective of the SPM terminal voltage V_{SPM} (STEP S3). Accordingly, similar to the case of the software control mode in starting the SPM 11, the driver circuit 121 drives the SPM 11 by the motor driving voltage V_{M} boosted to the high voltage V_{H}.

Incidentally, recent HDD spindle motors operate at a higher speed. In the case that the rotational speed of the SPM 11 is high, the higher motor driving voltage V_{M} is required, considering the starting time and efficiency of the SPM 11. When the motor driving voltage V_{M} higher than the supply voltage V_{CC} applied from the host is required, it is necessary to boost the supply voltage V_{CC}. In the embodiment, by using the voltage generator 122 capable of boosting the supply voltage V_{CC}, the motor driving voltage V_{M} higher than the supply voltage V_{CC} is realized.

In the case that the voltage generator 122 capable of boosting the supply voltage V_{CC} is used, the control of the voltage generator 122 with the hardware (voltage determination unit 124) according to the SPM terminal voltage V_{SPM} can reduce the power loss in the SPM driver 12. However, when the motor driving voltage VM is controlled with the hardware (voltage determination unit 124) according to the SPM terminal voltage VSPM, there is the possibility that a quick response cannot be carried out in starting the SPM 11 or in the case that the rotational speed of the SPM 11 is largely decreased. Therefore, it is thought that the control of the motor driving voltage V_{M} is carried out by the software processing of the CPU 13. However, when the control is carried out by the software processing of the CPU 13, the CPU 13 must periodically detect the terminal voltage of the SPM 11, which increases the load on the CPU 13.

On the contrary, in the embodiment, only when the SPM 11 is started and the rotational speed of the SPM 11 is largely decreased, the HDD is set in the software control mode, whereby the control of the motor driving voltage V_{M} is carried out by the software processing of the CPU 13. Specifically, in the software control mode, the CPU 13 (software) specifies the constant voltage V_{H} as the motor driving voltage V_{M} irrespective of the SPM terminal voltage V_{SPM} (rotational state of the SPM 11). The voltage generator 122 boosts the motor driving voltage V_{M} applied to the driver circuit 121 to the high voltage V_{H} according to the specification. Accordingly, unlike the hardware control mode, the SPM 11 is started by the large amount of current, so that the SPM 11 can be quickly started.

Further, in the embodiment, when the SPM 11 reaches the rated rotational speed or returns to the rated rotational speed, the mode of the HDD is changed from the software control mode to the hardware control mode. In the hardware control mode, the hardware (voltage determination unit 124) controls the motor driving voltage V_{M} according to the SPM terminal voltage V_{SPM} (rotational state of the SPM 11). It is apparent that the period when the SPM 11 is driven with the SPM driver 12 is almost the same as the period of the hardware control mode. That is, the period of the software control mode is very short. Accordingly, the increase in the load of the CPU 13 can be suppressed to the minimum amount. For the same reason, even if the motor driving voltage V_{M} is set to the high voltage (voltage V_{H}) irrespective of the SPM terminal voltage in the software control mode, the power loss is little in the SPM driver 12.

As described above, in the embodiment, the HDD is set to the software control mode in the case that the SPM 11 is required to start and in the case that the rotational speed of the SPM 11 is largely decreased. The rotational speed of the SPM 11 may largely decrease the due to an external impact. However, there is a time lag from the application of the impact to the decrease in the rotational speed of the SPM 11. Therefore, the embodiment adopts the configuration in which the mode of the HDD is changed to the software control mode with the CPU 13 not only in the case that the rotational speed of the SPM 11 is largely decreased (STEP S11), but also in the case that the impact exceeding the predetermined level is applied to the HDD from the outside (STEP S11a). For this reason, the shock sensor 14 detecting the impact applied to the HDD from the outside is provided in the HDD shown in FIG. 1. When the shock sensor 14 detects the application of the impact exceeding a predetermined level (threshold) to the HDD, the shock sensor 14 outputs an effective impact detection signal SD. The impact detection signal SD is guided to the CPU 13. When the shock sensor 14 outputs the effective impact detection signal SD (STEP S11a), the CPU 13 decides that the impact applied to the HDD largely decreases the rotational speed of the SPM 11. In this case, the CPU 13 sets the HDD to the software control mode (STEP S12) and specifies the high voltage V_{H} as the motor driving voltage V_{M} (STEP S2). Accordingly, when the impact applied to the HDD is a cause of the decrease in the rotational speed of the SPM 11, a more rapid response can be carried out compared with the change into the software control mode after the detection of the actual decrease in the rotational speed of the SPM 11 (STEP S11).

In the embodiment, the voltage generator 122 generates the voltage V_{H} in a manner that boosts the supply voltage V_{CC} in the software control mode. However, in the case that the supply voltage of the sufficient voltage level to start quickly and surely the SPM 11 can be utilized, the voltage generator 122 may generate the voltage V_{H} by stepping down the supply voltage V_{CC}. In the embodiment, the voltage generator 122 is built in the SPM driver 12. However, the voltage generator 122 may be provided independently of the SPM driver 12.

In the embodiment, the invention is applied to an HDD (Hard Disk Drive) in which a magnetic disk is used as the recording medium. However, the invention can be also applied to any disk drive including an SPM which rotates a disk, which uses the disk as the recording medium, such as a magneto-optical disk drive using a magneto-optical disk, or an optical disk drive using an optical disk.

What is claimed is:

1. A disk drive using a disk as a recording medium, comprising:
a spindle motor which rotates the disk;
a voltage determination unit which dynamically determines a first voltage for driving the spindle motor according to a rotational state of the spindle motor, the first voltage being a voltage required to maintain rotational speed of the spindle motor at the rated rotational speed;
a CPU which determines a second voltage value for driving the spindle motor by software processing in a software control mode;
a voltage generator which generates driving voltage for driving the spindle motor, the voltage generator generating the first voltage determined by the voltage determination unit as the driving voltage in a hardware control mode and generating the second voltage determined by the CPU as the driving voltage in the software control mode; and
a driver circuit which drives the spindle motor by the driving voltage generated with the voltage generator.

2. A disk drive according to claim 1, wherein the CPU sets the software control mode when the spindle motor is required to start and the CPU changes the software control mode to the hardware control mode when the start of the spindle motor is completed.

3. A disk drive according to claim 2, wherein the CPU changes the hardware control mode to the software control mode in accordance with a decrease in the rotational speed of the spindle motor during a period of the hardware control mode.

4. A disk drive according to claim 3, wherein the CPU changes the hardware control mode to the software control mode when a ratio of a decrease in the rotational speed of the spindle motor to a target rotational speed exceeds a predetermined threshold.

5. A disk drive according to claim 3, wherein the CPU changes the hardware control mode to the software control mode when a rate of a decrease in the rotational speed of the spindle motor exceeds a predetermined threshold.

6. A disk drive according to claim 3, wherein the CPU changes the hardware control mode to the software control mode when a decrease in the rotational speed of the spindle motor exceeds a predetermined threshold.

7. A disk drive according to claim 2, wherein the CPU changes the hardware control mode to the software control mode when an impact exceeding a predetermined threshold is applied to the disk drive during a period of the hardware control mode.

8. A disk drive according to claim 1, further comprising a voltage detector which detects a terminal voltage of the spindle motor; wherein the voltage determination unit determines the first voltage value according to a value of the terminal voltage detected with the voltage detector.

9. A disk drive according to claim 8, wherein the voltage determination unit includes an arithmetic unit which calculates the first voltage value from the value of the terminal voltage detected with the voltage detector.

10. A disk drive according to claim 9, wherein the arithmetic unit is an adder which adds the value of the terminal voltage detected with the voltage detector and a predetermined voltage margin, the adding result of the adder being used as the first voltage value.

11. A disk drive according to claim 8, wherein the voltage determination unit includes an arithmetic unit which calculates difference between the value of the driving voltage used for driving the spindle motor with the driver circuit and the value of the terminal voltage detected with the voltage detector, the first voltage value being determined according to the difference calculated with the arithmetic unit.

12. A disk drive according to claim 1, further comprising a multiplexer which selects one of a first data specifying the first voltage value determined by the voltage determination unit and a second data specifying the second voltage value determined by the CPU, the multiplexer selecting the first data specifying the first voltage value in the hardware control mode and selecting the second data specifying the second voltage value in the software control mode; wherein the voltage generator generates the driving voltage of the value indicated by the data selected with the multiplexer.

13. A method for controlling driving voltage applied to a driver circuit driving a spindle motor in a disk drive using a disk as a recording medium, the spindle motor rotating the disk, the method comprising:
determining dynamically a first voltage for driving the spindle motor according to a rotational state of the spindle motor by hardware processing, the first voltage being a voltage required to maintain rotational speed of the spindle motor at the rated rotational speed;
determining a second voltage for driving the spindle motor by software processing in a software control mode;
generating the first voltage determined by the hardware processing as the driving voltage in a hardware control mode; and
generating the second voltage determined by the software processing as the driving voltage in the software control mode.

14. The method according to claim 13, further comprising:
setting the software control mode when the spindle motor is required to start; and
changing the software control mode to the hardware control mode when the start of the spindle motor is completed.

15. The method according to claim 14, further comprising changing the hardware control mode to the software control mode in accordance with a decrease in the rotational speed of the spindle motor during a period of the hardware control mode.

16. The method according to claim 13, further comprising detecting a terminal voltage of the spindle motor; wherein the first voltage is determined according to the detected terminal voltage of the spindle motor.
